(19) United States
(12) Patent Application Publication
(10) Pub. No.: US 2003/0038472 A1
(43) Pub. Date: Feb. 27, 2003

(54) Restraint tightening system

(76) Inventors: Daniel A. O'Connell, Flatrock, MI (US); J. Derek O'Neal, Farmington Hills, MI (US)

Correspondence Address: John M. Lazarus, FOLEY & LARDNER, Firstar Center, 777 East Wisconsin Avenue, Milwaukee, WI, 53202-5367, US

(21) Appl. No.: 09/939,193

(22) Filed: Aug. 24, 2001

(51) Int. Cl. B60R 22/00

(52) U.S. Cl. 280/801.1; 280/802

(57) ABSTRACT

The present invention is directed to an apparatus for tightening a restraint, including a base having a passage for receiving the restraint and a one or more receptacles communicating with the passage, and one or more retention members movable between a first position and a second lockable position, wherein the restraint is loosened in the first position and the restraint is tightened in a second position. The present invention also relates to a method of tightening a restraint by inserting a restraint into a passage formed within a base, the passage communicating with one or more receptacles in the base and forming the restraint into the receptacles by moving one or more retention members between a first position and one or more second lockable positions, whereby the restraint is urged into a labyrinth configuration defined by the receptacles and the retention members in a second lockable position.

### FIELD OF THE INVENTION

The present invention generally relates to a system and method for use in tightening a restraint. In particular, the present invention relates to a system and method for tightening a flexible restraint used to secure an object. More particularly, the present invention relates to a system and method for tightening a restraining belt in a vehicle to secure an object to the vehicle.

### BACKGROUND OF THE INVENTION

It is generally known to provide restraining devices such as belts, straps or harnesses in vehicles to secure people and objects to the vehicle to improve safety during dynamic changes in vehicle motion such as collisions, rollovers, and abrupt maneuvers. Such restraining devices typically include a tightening apparatus for cinching the restraint into a final, tightened position for securing the person or object to the vehicle to restrict the degree of movement of the person and restrain objects during dynamic changes in vehicle motion. Exemplary tightening apparatus typically include manually adjustable vehicle seat belt buckles.

In such known apparatus for tightening restraining devices, the apparatus typically includes, for example, a segment of belt having a fixed length with a fixed end portion secured to the vehicle and a latching plate at the free end portion for engaging a second adjustable belt segment having a fixed end portion secured to the vehicle and latching buckle at its free end portion. The adjustable belt segment may be reversibly pulled over a gripping surface within the buckle by grasping and inwardly manipulating the buckle and then pulling the belt or buckle to obtain the desired length adjustment. The adjustable belt segment is secured in position against the gripping edge when the buckle orientation is returned to its latching position. Such apparatus typically have the disadvantage of necessitating an iterative approach to obtaining a properly tightened condition because of the repetitive buckle manipulations necessary to make subsequent adjustments.

Such apparatus also often have the disadvantage of being relatively inaccessible and difficult to tighten or loosen and may not allow for properly securing objects having internally-configured seat-belt passages which are necessary for proper three-dimensional restraint of the object's center of mass. Typical objects having such internal seat-belt passages include protective child safety seats and a variety of on-board, portable passenger-use devices which are increasingly being developed and adapted for multiple uses both within a vehicle and independent of the vehicle. Use of the typical seat-belt tightening devices with such portable objects may result in improperly securing the object because of the difficulty in manipulating the buckle. Such apparatus have the further disadvantage of attaching the seat belt directly to the object, thus necessitating coupling and uncoupling the seat-belt segments each time the object is installed or removed, and readjusting the tightening apparatus whenever a different object is installed.

Accordingly, it would be advantageous to provide a restraint tightening system that operated independently of a buckle. It would also be advantageous to provide a restraint tightening system that is simply and easily activated and released, and that required only a single operation to obtain a properly tightened condition. It would also be advantageous to include a coupling device for easily securing and releasing a variety of objects adapted to mount on the restraint tightening system. It would be further advantageous to provide a restraint tightening system having any one or more of these or other advantageous features.

### SUMMARY OF THE INVENTION

The present invention relates to a system for tightening a restraint. The apparatus includes a base having a passage for receiving the restraint and one or more receptacles communicating with the passage. The apparatus also includes one or more retention members movable between a first position and one or more second positions, wherein the restraint is loosened in the first position and the restraint is tightened in a second position.

The present invention also relates to a method of tightening a restraint by inserting a restraint into a passage formed within a base, the passage communicating with one or more receptacles in the base and urging the restraint into the receptacles by moving one or more retention members between a first position and one or more second lockable positions, whereby the restraint is cinched in a configuration defined by the receptacles and the retention members in a second lockable position.

### BRIEF DESCRIPTION OF THE DRAWINGS

FIG. 1 is an exploded perspective view of the restraint tightening system in a loosened position according to a preferred embodiment.

FIG. 2 is a perspective view of the assembled restraint tightening system in a tightened position according to a preferred embodiment.

FIG. 3 is a cross sectional view of the restraint tightening system in a loosened position taken along line 3-3 on FIG. 1, according to a preferred embodiment.

FIG. 4 is a cross sectional view of the restraint tightening system in a tightened position taken along line 4-4 on FIG. 2, according to a preferred embodiment.

FIG. 5 is a perspective view of the restraint tightening system in a tightened position with the cover removed according to an alternative embodiment.

FIG. 6 is an exploded perspective view of a releasable lock for a restraint tightening system according to a preferred embodiment.

FIG. 7 is a cross sectional view of the restraint tightening system taken along line 7-7 on FIG. 1 according to a preferred embodiment.

FIG. 8 is a perspective view of a restraint tightening system including a module attached to a base.

### DETAILED DESCRIPTION OF THE PREFERRED EMBODIMENTS

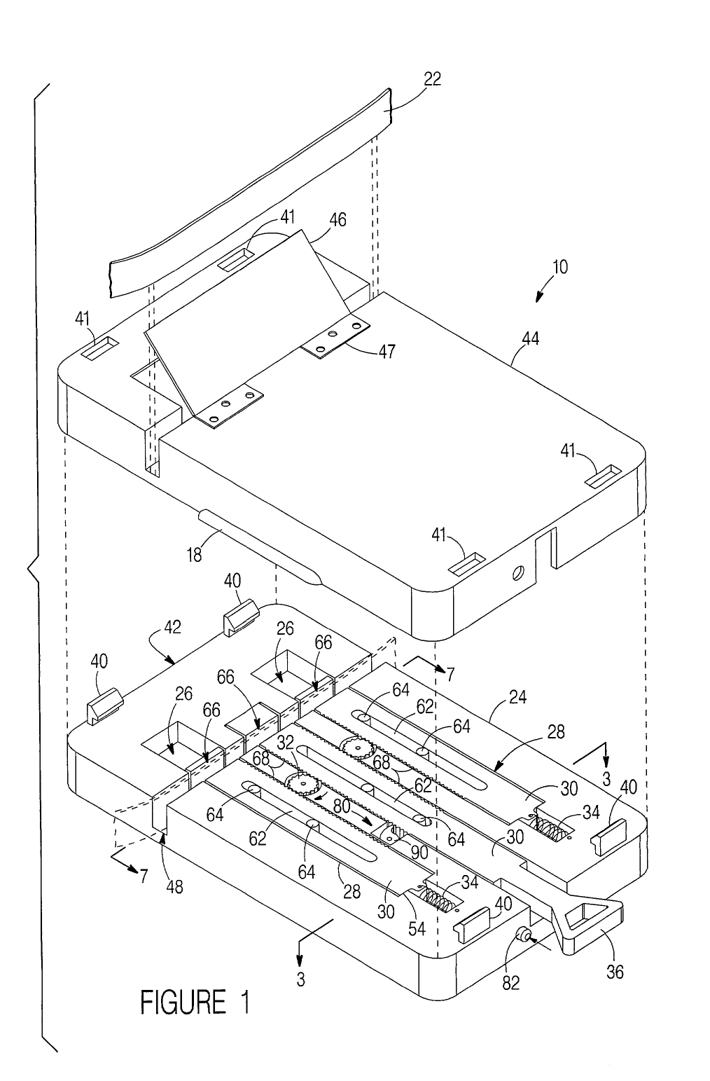

Referring to FIG. 1, a restraint tightening system 10 is shown according to a preferred embodiment. Tightening system 10 is configured for tightening an elongated restraint 22 (e.g. restraining strap, belt, cable, cord, etc.), but may also be adapted for use with a wide variety of other restraining members according to alternative embodiments. Restraint 22 generally has a first end portion and a second end portion that are secured to anchoring objects such as brackets on a vehicle floor or frame (not shown) and have an adjustment feature (not shown) for removing slack in the restraint between the first end portion and the second end portion.

Tightening system 10 includes a base 24 (e.g. housing, module, fixture, etc.) having internal cavities that form pockets 26 (e.g. receivers, receptacles, recesses, etc.) and channels 28 (e.g. passageway, track, groove, etc.) for receiving axially slidable retention members 30 (e.g. bars, blocks, etc.). Base 24 is configured to receive one or more alternating couplers 32 (e.g. links, gears, pivots, pulleys, etc.), a releasable locking mechanism 80, one or more biasing means shown as an extension spring 34 (e.g. tensioners, retractors, etc.) and an actuator shown schematically as a tightening handle 36 (e.g. tightener, operator, etc.).

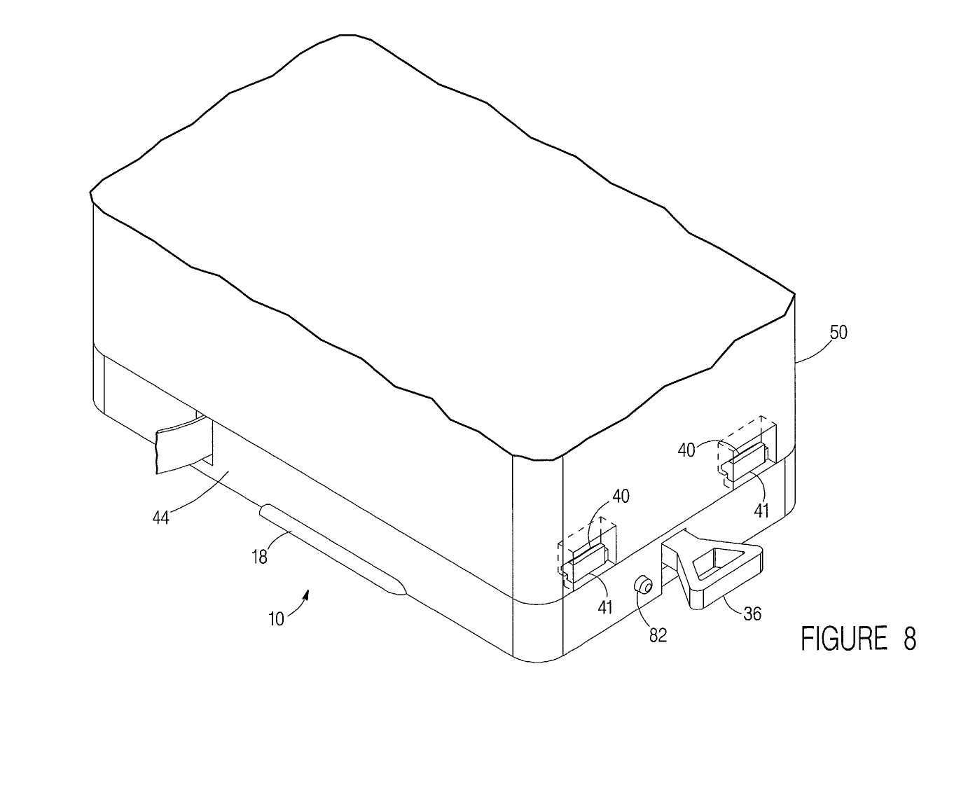

Referring further to FIG. 1, base 24 is shown according to a preferred embodiment. Base 24 and cover 44 are generally rectangular in shape and cover 44 may include a transporter shown as a handle 18 for conveniently transporting tightening system 10 when not in use. Handle 18 allows tightening system 10 to be conveniently transported among a variety of user-applications for tightening a restraint and attaching a module 50 (shown schematically in FIG. 8) to the base. Handle 18 may be integrally formed within cover 44 or base 24 (with a suitable cut away to allow installation of cover 44 over handle 18—not shown) and adapted to receive the hand of a user (not shown). Alternatively, handle 18 may be of any suitable shape and attached by any suitable means to allow tightening system 10 to be carried by hand for transport when not in use, and base 24 may have any suitable size and shape for housing restraint tightening components. Referring further to FIG. 1, cover 44 is preferably mounted onto base 24 during assembly and attached by any suitable means such as welds, rivets, adhesive or threaded fasteners (not shown).

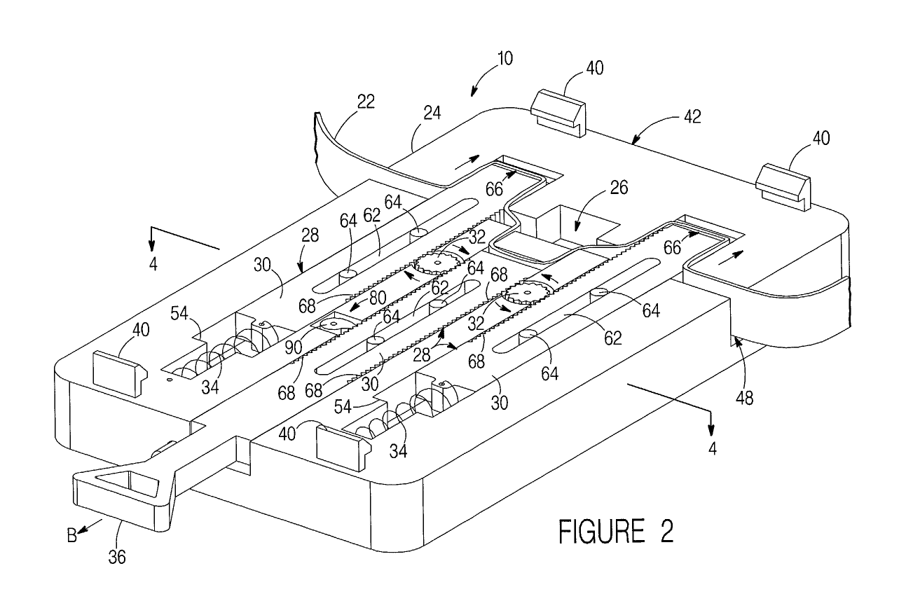

Referring further to FIGS. 1 and 2, base 24 may also include integral module couplers 40 shown schematically as latches but could also be catches, clasps, etc. Module couplers 40 may be formed on, or coupled to, the exterior of base 24 for selectively and releasably attaching a wide variety of portable modules that are desired to be restrained by restraint 22. Modules 50 may include any object useful particularly in a vehicle where restraining the object during vehicle motion may be desirable. Such modules may include, but are not limited to storage compartments, child safety seats, mobile office workstation components, audio equipment, media display devices, hot and cold storage containers, luggage, tools, toys, etc. Cover 44 is provided with openings shown schematically as slots 41 that fit over module couplers 40 to allow cover 44 to be mounted on base 24. In an alternative embodiment, module couplers 40 may be of a “ski-boot” type having receivers (e.g. receptacles, hooks, slots, etc.—not shown) and resilient catches (e.g. tabs, hooks, prongs, barbs, etc.) that capture corresponding structure on module 50 with a snap-lock or other suitable engagement. In further alternative embodiments, module couplers 40 may have any suitable form (e.g., buckles, straps, snaps, zippers, latches, locks, etc.) for securely retaining interchangeable modules 50 to base 24.

Base 24 is shown with a generally rectangular shape and having a support surface 42 for abutting securely against a stationary anchoring object (e.g. vehicle seat back, wall, floor, etc.—not shown), but may have any shape suitable for adapting to a stationary anchoring object and receiving one or more interchangeable modules 50. In a particularly preferred embodiment, base 24 and cover 44 are made of acrylonitrile butiadene styrene (ABS) plastic in an injection molding process, but may be made of any suitable material composition including but not limited to other plastics, metal, etc., or combinations thereof.

Base 24 includes a cover 44 including an access panel 46 (e.g. flap, door, cover, lid, etc.) for accessing an elongated opening shown as passageway 48 to insert and remove restraint 22 and may otherwise be closed when attaching modules (not shown) to base 24. Access panel 46 may be integrally formed with base 24, or flush-mounted to base 24 and may have any suitable closure system (e.g. cooperating projections, latches, catches, clasps, snap-fit detents, etc.—not shown) for maintaining panel 46 in a closed position. Panel 46 may partially cover passageway 48 as shown or may completely cover passageway 48. Panel 46 may also include separate hinges 47 as shown schematically in FIG. 1 or unitarily formed hinges consisting of grooves (not shown) in panel 46 for pivotally supporting one side of panel 46 to base 24 or cover 44. Hinges 47 include a torsion spring (not shown) or other suitable biasing means for urging panel 46 into a normally closed position. Panel 46 may be mounted on top of cover 44 as shown or may be recessed within cover 44 to provide a smooth, flat (i.e. “flush”) surface. In a further alternative embodiment, panel 46 may be formed on the top surface of base 24 and a corresponding panel access opening may be provided on cover 44 whereby the panel may be rotated upwardly through the access opening after the cover is installed.

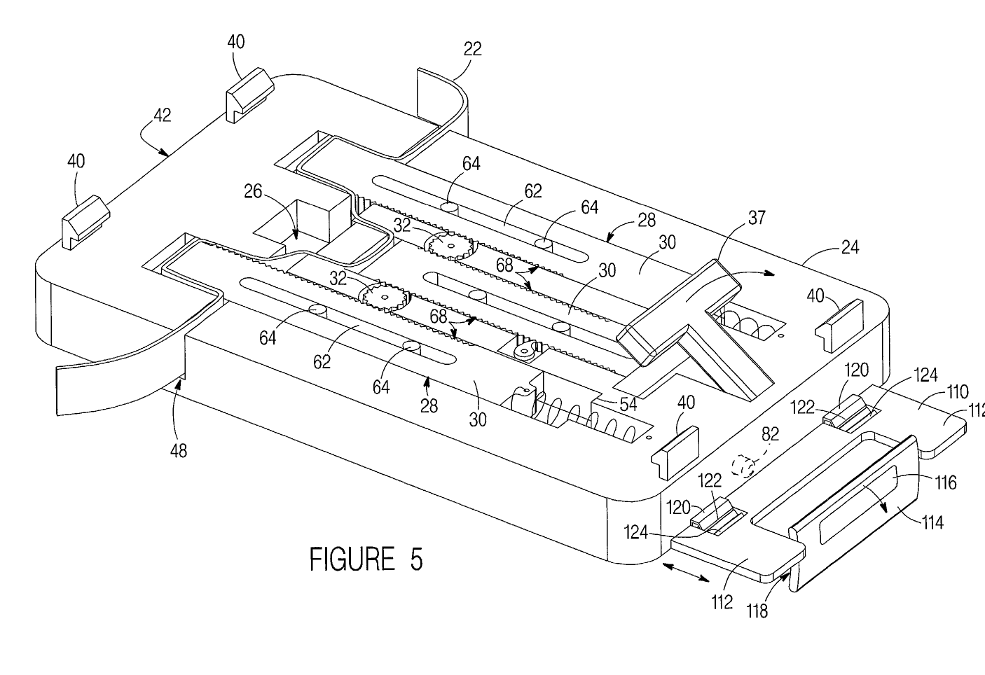

Referring to FIG. 5, a vertical base restraint is shown according to a preferred embodiment. The vertical base restraint includes a frame member 110 that is slidable extendable and retractable within a lower portion of base 24. Frame member 110 includes an open central portion creating arms 112 on the lateral sides of frame member 110. An interior side of arms 112 are pivotally attached to a restraining member shown as a flap 114 having an internal opening forming a handle 116 and a lower inwardly curved profile 118 for engaging the front profile of a vehicle seat (not shown). Flap 114 may be folded to a stowed position within the central opening between arms 112 whereby the frame member can be fully retracted within base 24. Frame member 110 may be partially withdrawn from base 24 to an appropriate position for engaging the front of the vehicle seat or other suitable structure by pulling outward on handle 116 and then folding flap 114 downward into a locked position and held in place by detents or other suitable structure to engage the front curved profile of the seat. Positioner tabs 120 are provided on base 24 (shown schematically in an open position) and are spring-biased to a closed position (not shown) where they conform substantially to the lower surface profile of base 24. When frame member 110 is withdrawn, tabs 120 are forced upwards whereby a lower edge 122 of tabs 120 are urged into engagement with a series of cooperating ridges 124 on frame member 110 in a ratcheting manner.

Referring to FIGS. 1-4, base 24 is formed with internal cavities that provide receptacles such as pockets 26 and channels 28 for receiving retention members 30 in both a first loosened position and one or more second tightened positions, and for receiving alternating couplers 32 and releasable locking mechanism 80. Channels 28 may also be shaped with stops 54 (e.g. shoulders, ledges, protrusions, etc.) for limiting the axial travel range of retention members 30. Base 24 further includes a cavity shown schematically as a stepped circular bore 56 for receiving release rod 83 and release extension 82. Biasing means 34 are provided within channels 28 for biasing retention members 30 to the first loosened position. In a particularly preferred embodiment, biasing means 34 is an extension spring having a first end connected to an end of channel 28 and a second end connected to an end of one or more retention members 30. Alternatively, biasing means 34 may be a compression spring (not shown) configured within receptacle 26 for urging retention members 30 into the first loosened position.

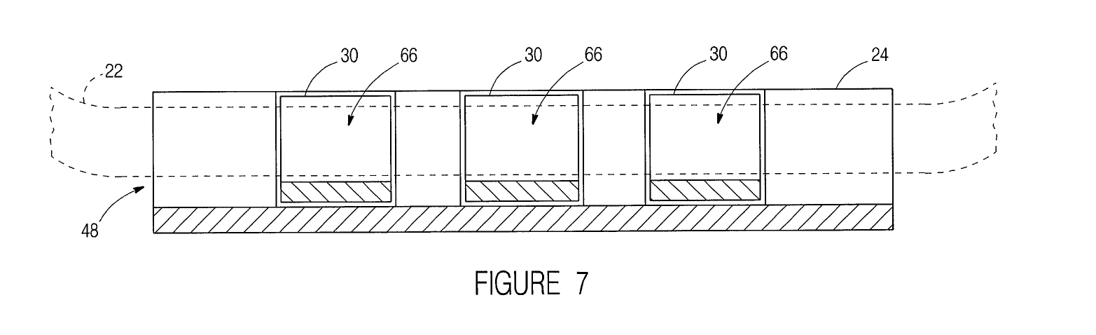

Referring further to FIGS. 1-4 and 7, retention members 30 are elongated rectangular members capable of moving along a longitudinal axis between a first loosened position and one or more second tightened positions. Retention members 30 may have a guiding track 62 (e.g. slot, groove, hollow, etc.) engaging a guiding member 64 (e.g. projection, pin, peg, etc.) coupled to base 24 for improving the lateral stability of retention members 30. The top surface of guiding members 64 may be configured slightly above the top surface of retention members 30 for providing an attachment surface for cover 44. Retention members 30 preferably have a holder 66 (e.g. “U” channel, slot, groove, passage, etc.) for receiving and capturing restraint 22 and located to align with passage 48 when retention members 30 are in the first loosened position whereby holder 66 repositions captured restraint 22 into a labyrinth configuration when retention members 30 are moved to a second tightened position. Retention members 30 include a drive mechanism 68 (e.g. linear gear, etc.) along each side that is adjacent to other retention members 30. One or more couplers 32 are rotatably coupled to base 24. Coupler 32 has a size and intermediate position to engage the parallel drive mechanisms 68 of two restraining members, whereby axial movement of one retention member 30 in one direction imparts a rotation on coupler 32, causing one or more adjacent retention members 30 to move in the opposite longitudinal direction. In a particularly preferred embodiment, drive mechanism 68 is a linear gear or rack and coupler 32 is a pinion gear made from steel or aluminum. According to an alternative embodiment, coupler 32 and drive mechanism 68 may be replaced by a pulley and cable system (not shown) for imparting alternating, reciprocating movement between retention members 30.

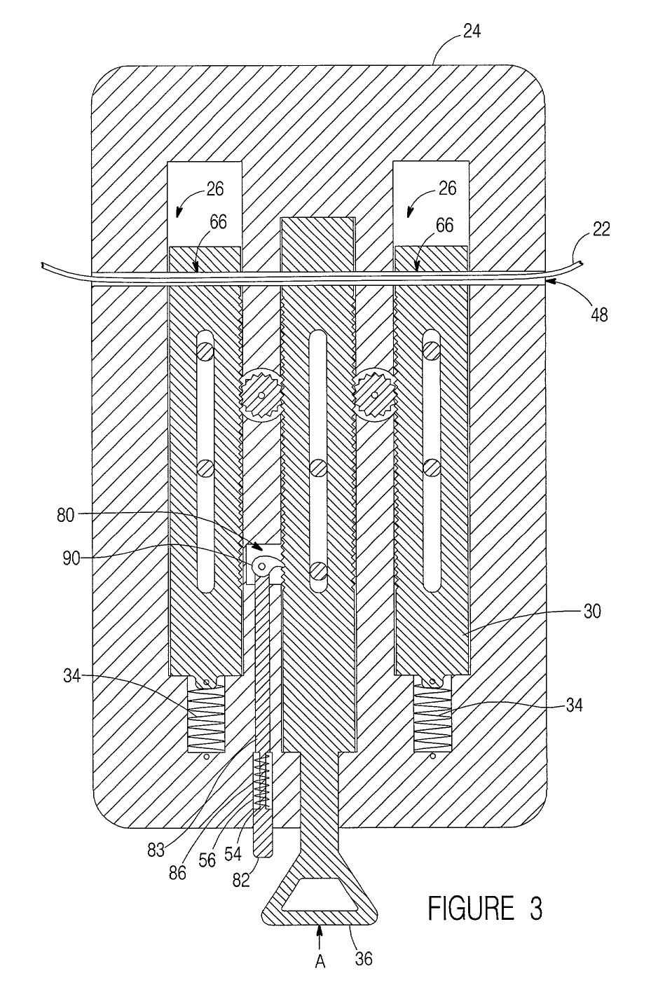

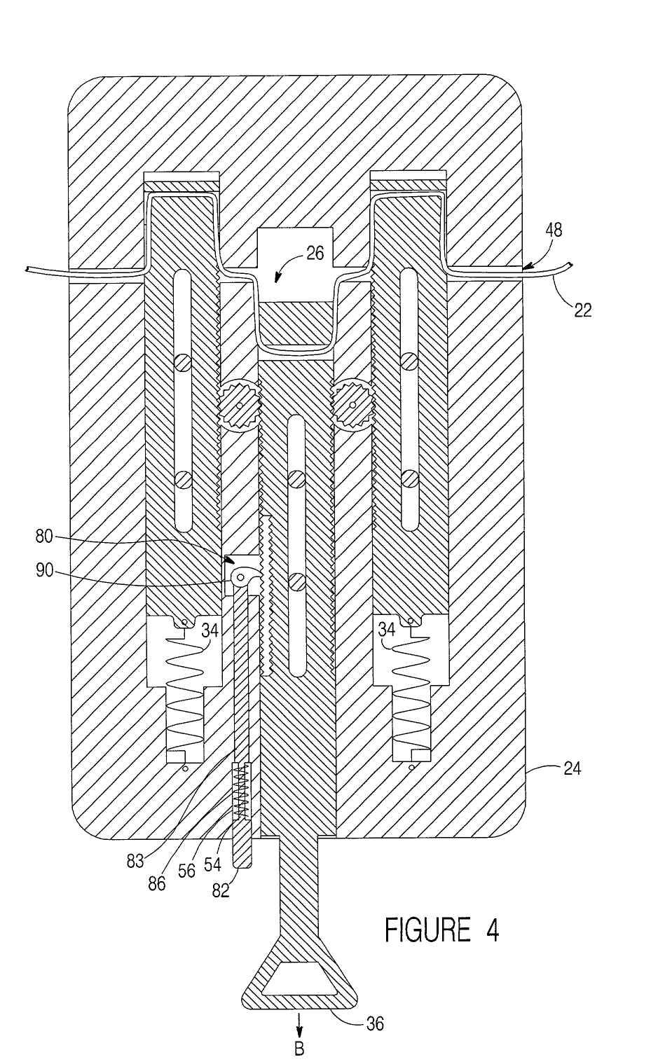

Referring further to FIGS. 3 and 4, retention members 30 may be aligned so that holders 66 and passage 48 are in a generally straight configuration to create a substantially linear travel path for a segment of restraint 22 inserted into passage 48. Retention members 30 may be slidably and reciprocatingly movable in alternating directions along a longitudinal axis between the first loosened position and one or more adjustable and lockable second tightened positions by repositioning tightening handle 36. When retention members 30 are moved by tightening handle 36 in direction “B” from the first loosened position to a second tightened position, restraint 22 is cinched into a labyrinth configuration causing tightening of restraint 22 by increasing the linear travel distance of the restraint between the first position and a second position.

Passage 48 is generally straight for inserting restraint 22, and the passage walls may have a flat vertical engagement profile with a smooth or textured surface for improving frictional retention of restraint 22 (not shown) for receiving flexible belts, straps or the like. According to alternative embodiments, the walls of passage 48 and pockets 26 may have a textured or contoured engagement profile (not shown) for receiving flexible restraints having various matching profiles. Further, passage 48 may have a curved path (not shown) to relieve stress at the outward ends of passage 48. Pockets 26 are sized to operatively receive retention members 30 in one or more second positions and include a lateral clearance relative to each side of retention member 30 corresponding generally to the width of restraint 22.

Referring to FIG. 3, releasable lock 80 is shown according to a preferred embodiment. Releasable lock 80 provides adjustable and lockable movement of retention members 30 within pockets 26. Releasable lock 80 includes a ratcheting pawl assembly 90 pivotally coupled to base 24 for ratchetably engaging drive mechanism 68 on any one or more retention members 30, and a release rod 83 and release extension 82 shown schematically as a pushbutton, slidably captured within stepped circular bore 56 of base 24. Release rod 83 has a first end portion engaging pawl assembly 90 and a second end portion having a stepped shoulder providing a reduced diameter segment 54 having external threads for receiving release an internal threaded portion of release extension 82 thereon. Release extension 82 protrudes beyond an exterior surface of base 24, providing convenient access for manual activation. Reduced diameter segment 54 provides a space for accommodating a biasing means 86 (e.g. coil spring, etc.) for urging release rod 83 into locking engagement with pawl assembly 90. Activating release extension 82 against biasing means 86 causes pawl assembly 90 to disengage drive mechanism 68, allowing retention members 30 to unlock and return to the first loosened position.

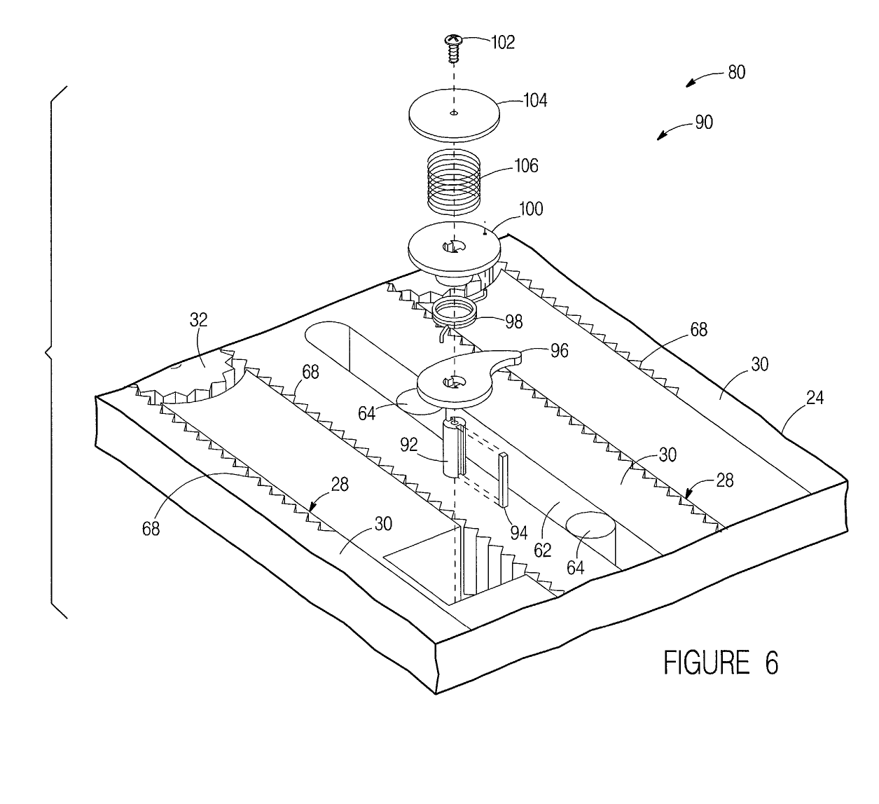

Referring to FIG. 6, ratcheting pawl assembly 90 of releasable lock 80 is shown according to a particularly preferred embodiment. Pawl assembly 90 is mounted to a ratchet post 92 projecting perpendicularly from base 24 and rotationally restricted by anti-rotation pin 94. Pawl 96 is biased to engage drive mechanism 68 by a torsion spring 98 coupled to an anti-rotation bushing 100 that is keyed to ratchet post 92. A threaded fastener 102 secures a washer 104 and compression spring 106 for biasing pawl assembly 90 for axial engagement with drive mechanism 68.

Referring to FIGS. 1 and 2. Tightening handle 36 is shown according to a preferred embodiment. One or more retention members 30 may be moved from the first loosened position to one or more second tightened positions in direction “B” by tightening handle 36 which is operatively coupled to one or more of retention members 30. Tightening handle 36 may be a longitudinally projecting handle attached to a retention member 30 that is moved from a loosened position to a tightened position by pulling actuator 36. Retention members 30 may be moved from the tightened position to the loosened position by activating release extension 82 and pulling actuator 36 in direction “A”.

Referring to FIG. 5, a tightening handle 37 is shown according to an alternative embodiment. Tightening handle 37 may comprise a lever engaging a cam (not shown) or standard ratchet mechanism (not shown) that is operatively coupled to a retention member 30 for repositioning retention members 30.

It is important to note that the construction and arrangement of the elements of the apparatus for tightening a restraint in the exemplary embodiments is illustrative only. Although only a few exemplary embodiments of the present invention have been described in detail in this disclosure, those skilled in the art who review this disclosure will readily appreciate that many modifications are possible in the exemplary embodiments (such as variations in sizes, structures, shapes and proportions of the various elements, mounting arrangements, use of materials, orientations, colors, combinations of shapes, etc.) without materially departing from the novel teachings and advantages of the invention. For example, the apparatus may be used as a restraint tightening mechanism for tightening tie-down straps or load-binding straps on the interior or exterior of any vehicle (such as an automobile, van, sport-utility vehicle, truck, farm or construction equipment, boat, airplane, train, delivery cart, etc.). According to other alternative embodiments, the apparatus may be used for tightening ropes, straps, cords or cables in any application in which achieving a taut rope, strap, cord or cable is desirable. Further, it is readily apparent that the coupling base, passage, receptacles and retention members can be made in a wide variety of shapes, sizes, thickness, and engagement profiles and engagement profile surface textures. It is also readily apparent that the latches may be formed in a variety of shapes and configurations for adaptation to a broad variety of modules to be restrained. According to other alternative embodiments, the drive mechanism and alternating link may include, for example, a cable and pulley arrangement or other device capable of transmitting alternating and reciprocating linear motion of the retention members. Accordingly, all such modifications are intended to be within the scope of the invention as defined in the appended claims.

What is claimed is:

1. An apparatus for tightening a restraint, comprising:
a base having an elongated opening for receiving the restraint;
one or more receptacles communicating with the passage;
one or more retention members adjustably movable between a first position and at least one second lockable position;
wherein the restraint is loosened in the first position and the restraint is tightened in a second position.

2. The apparatus of claim 1, wherein the retention members are reversably and slidably movable between the first position and each second position.

3. The apparatus of claim 2, wherein the retention members in each second position at least partially enter the receptacles.

4. The apparatus of claim 3, wherein the passage is a slot.

5. The apparatus of claim 4, wherein the passage and retention members have an engagement profile adapted to engage the restraint.

6. The apparatus of claim 5, wherein the restraint is cinched into a labyrinth configuration when the restraining members engage the receptacles.

7. The apparatus of claim 6, further comprising a drive mechanism.

8. The apparatus of claim 7, wherein the drive mechanism includes a gear disposed on one or more retention members and an alternating link.

9. The apparatus of claim 8 wherein the gear is a linear gear.

10. The apparatus of claim 9, wherein the alternating link includes one or more pinion gears engaging the linear gear of the one or more retention members in a rack-and-pinion configuration.

11. The apparatus of claim 10, further comprising a pawl having ratchetable engagement with the linear gear of one or more of the retention members, wherein the retention members are releasably locked in an adjustable range between the first position and each second position.

12. The apparatus of claim 11, further comprising a release member for selectively unlocking the one or more restraining members.

13. The apparatus of claim 12, wherein one or more of the retention members has an actuator for moving the retention members in an adjustable range between the first position and each second position.

14. The apparatus of claim 13, wherein the actuator is a handle.

15. The apparatus of claim 14, wherein the restraint is cinched into a tightened position when the retention members are locked in a second position.

16. The apparatus of claim 15, wherein the restraint is a restraint belt for a vehicle.

17. The apparatus of claim 16, wherein the base has one or more latches for holding a portable module.

18. The apparatus of claim 17, wherein the module is secured to the vehicle when the restraint belt is cinched into a tightened position.

19. A method of tightening a restraint, comprising:
inserting a restraint into a passage formed within a base, the passage communicating with one or more receptacles in the base;
moving one or more retention members from a first position to a second lockable position within the receptacles;
cinching the restraint into the receptacles.

20. The method of claim 19, wherein the step of cinching the restraint further comprises forming the restraint into a labyrinth configuration.

21. The method of claim 20, further comprising the step of attaching a portable module to the base.

22. The method of claim 21, further comprising the step of loosening the restraint by actuating a release button.

23. A restraint tightening system, comprising:
means for capturing a restraint in a first position within a base;
means for cinching the restraint into any of a plurality of second positions, whereby the restraint is urged into a labyrinth configuration;
means for locking the restraint in the second position; and
means for releasing the restraint from the second position.

24. The restraint tightening system of claim 23, further comprising means for attaching one or more portable modules to the base.

25. The restraint tightening system of claim 24, further comprising means for inserting and removing the restraint through a top side of the base.

26. The restrain tightening system of claim 25, further comprising means for urging one or more retention members into a loosened position.

27. An apparatus for securing a module comprising:
a base having a passge for receiving the restraint;
one or more receptacles communicating with the passage;
one or more retention members adjustably movable between a first position and at least one second lockable position;
wherein the restraint is loosened in the first position and the restraint is tightened in a second position;
one or more releasable couplings communicating with the module and the base for attaching the module to the base.

28. The apparatus of claim 27 wherein the module is taken from the group consisting of storage compartments, child safety seats, mobile office workstation components, audio equipment, media display devices, hot and cold storage containers, luggage, tools, toys and computers.

29. The apparatus of claim 28, wherein the module is adapted for interchangeable attachment to the base.

30. The apparatus of claim 27, further comprising an adjustable, selectively retractable restraint for restraining the apparatus in a vertical direction.
